(19) United States
(12) Patent Application Publication
(10) Pub. No.: US 2008/0022492 A1
(43) Pub. Date: Jan. 31, 2008

(54) Hinge structure

(75) Inventors: Yung-Ta Lee, Sinjhuang City (TW); Chia-Cheng Chen, Sinjhuang City (TW); Hung-Ta Kuo, Sinjhuang City (TW)

Correspondence Address: John G. Chupa;Law Offices of John Chupa & Associates, P.C., Suite 50, 28535 Orchard Lake Road, Farmington Hills, MI, 48334, US

(73) Assignee: Jarllytec Co., Ltd.

(21) Appl. No.: 11/724,086

(22) Filed: Mar. 14, 2007

(30) Foreign Application Priority Data
Jul. 28, 2006 (TW) 095213281

(51) Int. Cl. E05D 11/08

(52) U.S. Cl. 16/337

(57) ABSTRACT

A hinge includes a pivot shaft, which has a mounting base at one end for mounting, and a cylindrical shaft body at the other end that is divided into a first section and a second section and has a first flat mill face on the first section at one side and a second flat mill face on the second section at an opposite side, and two knuckle members respectively sleeved onto the first section and second section of the cylindrical shaft body of the pivot shaft in reversed directions, each knuckle member having a flat face formed on the inside wall and abutted against the first flat mill face or second flat mill face such that when the two knuckle members are synchronously rotated relative to the pivot shaft, the torque produced between one knuckle member and the pivot shaft and the torque produced between the other knuckle member are balanced.

### BACKGROUND OF THE INVENTION

1. Field of the Invention

The present invention relates to hinges and more particularly, to sleeve joint type hinge structure.

2. Description of the Related Art

A consumer electronic product with a lifting cover such as mobile computer, electronic dictionary, mobile video player, cell phone, etc., commonly uses a hinge to couple the cover to the base member so that the cover can be opened from or closed on the base member. Therefore, the hinge determines the quality level of the product. A good hinge allows positive positioning, and does not cause noises during operation.

There is known a radial friction type hinge (the so-called sleeve joint type hinge), which comprises a female hinge member, which defines therein an axle hole, a male hinge member, which has a split shaft body positioned in the axle hole. The split shaft body of the male hinge member has two friction portions disposed in friction engagement with the peripheral wall of the axle hole of the female hinge member. However, this design of sleeve joint type hinge is not durable in use because the friction portions wear quickly with use.

Taiwan patent publication no. M256670, issued to the present inventor, discloses an auto-return hinge. According to this design, the hinge comprises a knuckle member and a pivot shaft. The knuckle member has a barrel-like knuckle body, a longitudinal split cut through the peripheral wall of the barrel-like knuckle body, and a flat face on the inside wall of the barrel-like knuckle body. The pivot shaft has a cylindrical shaft body. The cylindrical shaft body has a diameter slightly greater than the inner diameter of the barrel-like knuckle body, and at least one mill face on the periphery. The cylindrical shaft body of the pivot shaft is inserted into the barrel-like knuckle body. When the flat face of the barrel-like knuckle body of the knuckle member touches the mill face of the cylindrical shaft body, the barrel-like knuckle body contracts, thereby providing a lateral thrust for enabling the mill face to be moved with the pivot shaft to the flat face of the knuckle member. However, because the barrel-like knuckle body of the knuckle member and the cylindrical shaft body of the pivot shaft do not have a true roundness, a torque will be produced when the pivot shaft is rotated forwards or backwards relative to the knuckle member.

Therefore, it is desirable to provide a hinge that eliminates the aforesaid problem.

### SUMMARY OF THE INVENTION

The present invention has been accomplished under the circumstances in view. According to one aspect of the present invention, the hinge comprises a pivot shaft, and two knuckle members. The pivot shaft has a cylindrical shaft body and a mounting base axially extended from one end of the cylindrical shaft body. The cylindrical shaft body comprises a first section connected to the mounting base, a second section axially connected to one end of the first section opposite to the mounting base, a first flat mill face longitudinally formed on the first section at one side, and a second flat mill face longitudinally formed on the second section at an opposite side. The two knuckle members are respectively sleeved onto the first section and second section of the cylindrical shaft body of the pivot shaft. The two knuckle members each comprise a knuckle body having a barrel-like peripheral wall, a longitudinal split cut through the barrel-like peripheral wall of the knuckle body, a flat face on an inner surface of the barrel-like peripheral wall of the knuckle body, and a mounting portion extended from the barrel-like peripheral wall of the knuckle body. The two knuckle members are respectively sleeved onto the first section and second section of the cylindrical shaft body of the pivot shaft in reversed directions to have the respective flat faces respectively abut against the first flat mill face and the second flat mill face. When the two knuckle members are synchronously rotated relative to the pivot shaft, the knuckle body of one knuckle member imparts a first torque to the pivot shaft in a first direction, and the knuckle body of the other knuckle member imparts a second torque to the pivot shaft in a second direction reversed to the first direction so that the first torque and the second torque are balanced.

According to another aspect of the present invention, the mounting base of the pivot shaft has at least one mounting hole for mounting.

According to still another aspect of the present invention, the mounting portion of each knuckle member extends radially from the associate knuckle body, having at least one mounting hole for mounting. Alternatively, the mounting portion of each knuckle member can be extended axially from one end of the associate knuckle body.

According to still another aspect of the present invention, the first section and second section of the cylindrical shaft body of the pivot shaft each have an oil groove that extends spirally around the periphery of the cylindrical shaft body of the pivot shaft.

According to still another aspect of the present invention, the pivot shaft further comprises a collar connected between the mounting base and the cylindrical shaft body, and an annular groove extending around of the periphery of the cylindrical shaft body and abutted against one side of the collar.

### BRIEF DESCRIPTION OF THE DRAWINGS

FIG. 1a is an exploded view of a hinge according to the present invention.

FIG. 1b corresponds to FIG. 1 when viewed from another angle.

FIG. 2 is an elevational assembly view of the hinge according to the present invention.

FIG. 3a is a sectional view taken along line A-A of FIG. 2.

FIG. 3b is a sectional view taken along line B-B of FIG. 2.

FIG. 4a corresponds to FIG. 3a when viewed from another angle.

FIG. 4b corresponds to FIG. 3b when viewed from another angle.

FIG. 5a corresponds to FIG. 3a, but showing the knuckle members rotated relative to the pivot shaft.

FIG. 5b corresponds to FIG. 3b, but showing the knuckle members rotated relative to the pivot shaft.

### DETAILED DESCRIPTION OF THE PREFERRED EMBODIMENT

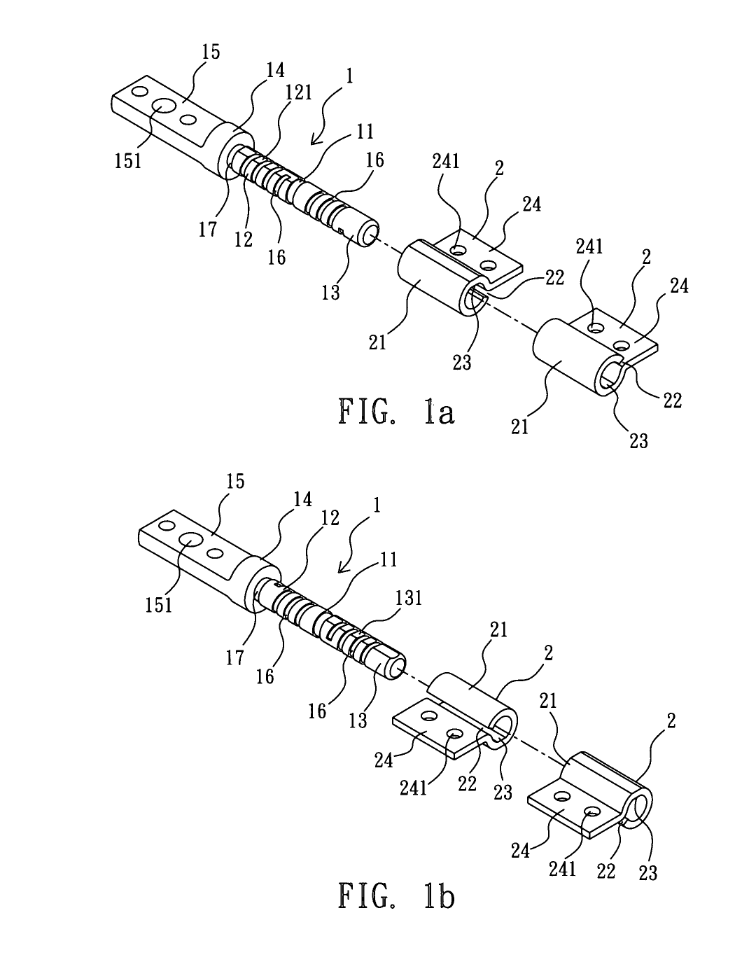

Referring to FIGS. 1a and 1b, a hinge in accordance with the presently shown invention is comprised of a pivot shaft 1, and two knuckle members 2.

The pivot shaft 1 is a rod member having a cylindrical shaft body 11, a mounting base 15 axially aligned with the cylindrical shaft body 11 in line, and a collar 14 connected between the cylindrical shaft body 11 and the mounting base 15. The cylindrical shaft body 11 is divided into axially aligned first section 12 and second section 13, having a first flat mill face 121 on the first section 12 at one side and a second flat mill face 131 on the second section 13 at an opposite side. According to this embodiment, the mounting base 15 is shaped like a flat bar, having at least one mounting through hole 151 through which fastening members such as mounting screws are inserted to affix the pivot shaft 1 to a device, for example, the cover of a mobile electronic device. Alternatively, the mounting base 15 can be made having a polygonal cross section for fitting into a polygonal mounting hole on a device.

Further, the first section 12 and the second section 13 each have at least one oil groove 16 on the periphery for accommodating lubricating grease to prevent friction and noise. According to this embodiment, the oil groove 16 extends spirally around the periphery of the first section 12 and/or the second section 13. Further, an annular groove 17 extends around the periphery of the second section 12 and abutted against one side of the collar 14 for accommodating more lubricating grease to prevent adhesion of excessive lubricating grease to electronic parts.

The two knuckle members 2 are axially aligned in line and arranged in a reversed manner, each having a barrel-like knuckle body 21, a longitudinal split 22 cut through the peripheral wall of the barrel-like knuckle body 21, at least one flat face 23 on the inside wall of the barrel-like knuckle body 21, a mounting portion 24 extended from the peripheral wall of the barrel-like knuckle body 21 at one side of the longitudinal split 22, and at least one mounting through hole 241 on the mounting portion 24 through which at least one fastening member such as mounting screw is respectively inserted to affix the respective knuckle member 2 to another device, for example, the base member of the mobile electronic device. The longitudinal split 22 makes the barrel-like knuckle body 21 expansible. According to this embodiment, the flat mounting portion 24 is a flat member extending radially from the barrel-like knuckle body 21. Alternatively, the mounting portion 24 can be extended axially from one end of the barrel-like knuckle body 21. The mounting portion 24 can also be shaped like a polygonal bar for fitting into a polygonal coupling hole.

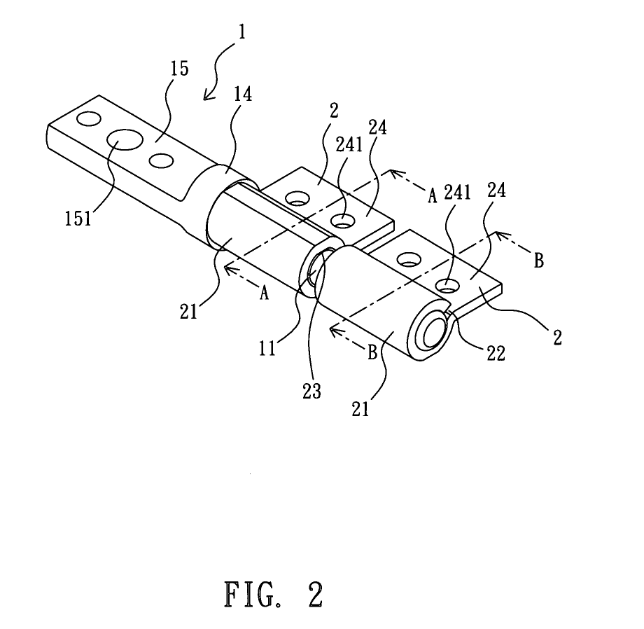

Referring to FIG. 2 and FIG. 1 again, aim the flat face 23 of one knuckle member 2 axially at the mill face 131 on the second section 13 of the cylindrical shaft body 11 of the pivot shaft 1, and then sleeve the knuckle member 2 onto the second section 13 of the cylindrical shaft body 11 of the pivot shaft 1, and then rotate the knuckle member 2 relative to the pivot shaft 1 to have the flat face 23 in axial alignment with the mill face 121 of the first section 12, and then sleeve the knuckle member 2 onto the first section 12. Thereafter, aim the flat face 23 of the other knuckle member 2 axially at the mill face 131 on the second section 13 of the cylindrical shaft body 11 of the pivot shaft 1, and then sleeve the knuckle member 2 onto the second section 13 of the cylindrical shaft body 11 of the pivot shaft 1. FIG. 2 illustrates the two knuckle members 2 mounted on the cylindrical shaft body 11 of the pivot shaft 1.

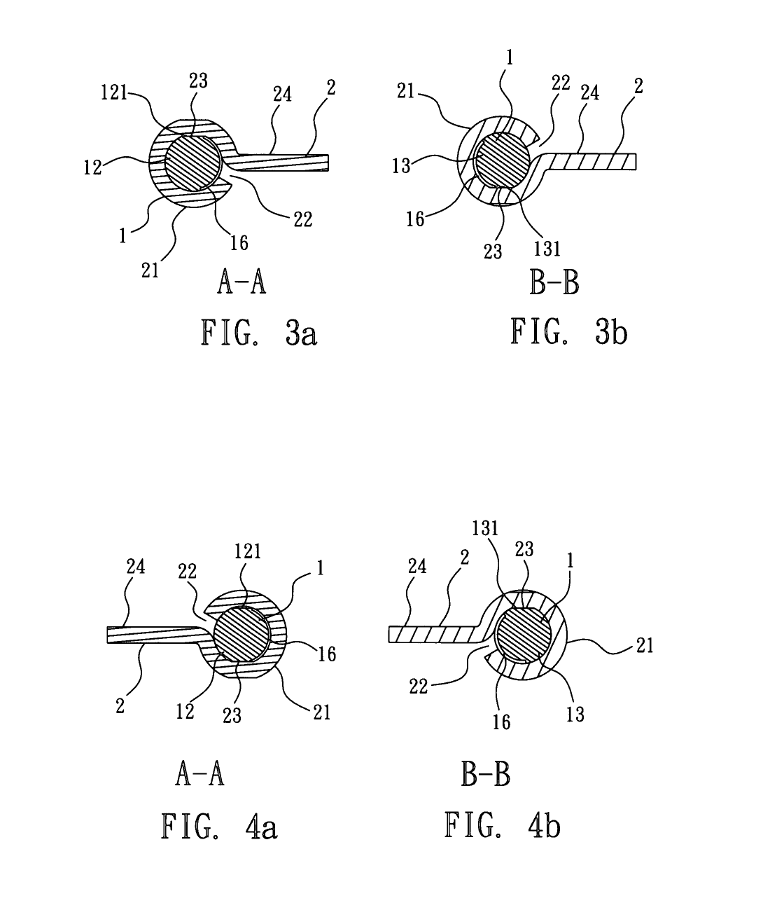

Referring to FIGS. 3a and 3b, after mounting of the knuckle members 2 on the pivot shaft 1, the flat faces 23 of the knuckle members 2 are respectively abutted against the mill faces 121 and 131 of the cylindrical shaft body 11 of the pivot shaft 1, and the two arched arm-like peripheral wall portions of the barrel-like knuckle body 21 of each knuckle member 2 at the two sides of the associating longitudinal split 22 impart a clamping force to the cylindrical shaft body 11 of the pivot shaft 1 for enabling a torque to be produced between the cylindrical shaft body 11 of the pivot shaft 1 and the inside wall of the barrel-like knuckle body 21 of each knuckle member 2, and therefore the knuckle members 2 are positively secured to the cylindrical shaft body 11 of the pivot shaft 1.

Referring to FIGS. 4a and 4b, because the peripheral distance of the first section 12 or second section 13 between the two opposite sides the mill face 121 or 131 is smaller than the diameter of the cylindrical shaft body 11 of the pivot shaft 1, the barrel-like knuckle body 21 of each knuckle member 2 is forced to expand at the initial stage when the pivot shaft 1 is rotated outwards, and a respective torsional force is respectively produced between the first section 12 and second section 13 and the inside wall of the barrel-like knuckle body 21 of each of the knuckle members 2. When the mill faces 121 and 131 are moved to the longitudinal split 22 and the periphery of the cylindrical shaft body 11 touches the flat face 23 of each knuckle member 2, the barrel-like knuckle body 21 of each of the knuckle members 2 expands to the maximum, and the value of the torsional force reaches the maximum.

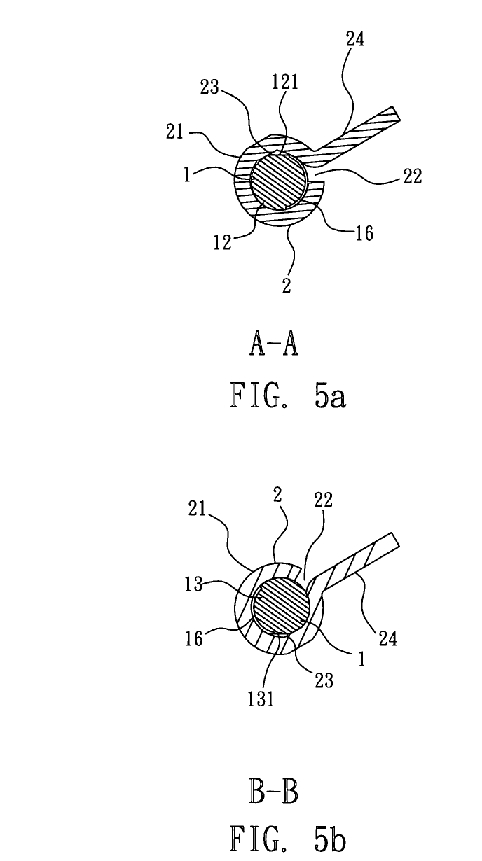

Referring to FIGS. 5a and 5b, when the pivot shaft 1 is rotated inwards and one side of each of the first mill face 121 and second mill face 131 respectively touches the corresponding flat face 23 of the associating knuckle member 2, the barrel-like knuckle body 21 of each of the knuckle members 2 contracts, thereby providing a lateral thrust to move the first mill face 121 and second mill face 131 to the corresponding flat faces 23, and therefore the first mill face 121 and the second mill face 131 are respectively abutted to the flat faces 23 of the knuckle members 2.

Therefore, when the two knuckle members 2 are rotated relative to the first section 12 and second section 13 of the cylindrical shaft body 11 of the pivot shaft 1, the torque produced between one knuckle member 2 and the pivot shaft 1 and the torque produced between the other knuckle member 2 and the pivot shaft 1 are balanced.

By means of the application of the present invention, the barrel-like knuckle body of each knuckle member forms a spring member that can be forced to expand by an external force and will return to its former shape when the external force is disappeared, so that the mill faces of the pivot shaft can be automatically moved to the flat faces of the knuckle members. Further, because the two knuckle members respectively sleeved onto the pivot shaft in reversed directions, the torque produced between one knuckle member and the pivot shaft and the torque produced between the other knuckle member and the pivot shaft are balanced.

Although a particular embodiment of the invention has been described in detail for purposes of illustration, various modifications and enhancements may be made without departing from the spirit and scope of the invention.

What is claimed is:

1. A hinge comprising:
a pivot shaft, said pivot shaft having a cylindrical shaft body and a mounting base axially extended from one end of said cylindrical shaft body, said cylindrical shaft body comprising a first section connected to said mounting base, a second section axially connected to one end of said first section opposite to said mounting base, a first flat mill face longitudinally formed on said first section at one side, and a second flat mill face longitudinally formed on said second section at an opposite side; and
two knuckle members respectively sleeved onto the first section and second section of said cylindrical shaft body of said pivot shaft, said two knuckle members each comprising a knuckle body having a barrel-like peripheral wall, a longitudinal split cut through the barrel-like peripheral wall of said knuckle body, a flat face on an inner surface of the barrel-like peripheral wall of said knuckle body, and a mounting portion extended from the barrel-like peripheral wall of said knuckle body, said two knuckle members being respectively sleeved onto the first section and second section of said cylindrical shaft body of said pivot shaft in reversed directions to have the respective flat faces respectively abut against said first flat mill face and said second flat mill face;
wherein when the two knuckle members are synchronously rotated relative to said pivot shaft, the knuckle body of one of said knuckle members imparts a first torque to said pivot shaft in a first direction, and the knuckle body of the other of said knuckle members imparts a second torque to said pivot shaft in a second direction reversed to said first direction so that said first torque and said second torque are balanced.

2. The hinge as claimed in claim 1, wherein said mounting base of said pivot shaft has at least one mounting hole for mounting.

3. The hinge as claimed in claim 1, wherein said mounting portion of each of said knuckle members extends radially from the associate knuckle body, having at least one mounting hole for mounting.

4. The hinge as claimed in claim 1, wherein the first section and second section of said cylindrical shaft body of said pivot shaft each have an oil groove.

5. The hinge as claimed in claim 4, wherein said oil groove extends spirally around the periphery of said cylindrical shaft body of said pivot shaft.

6. The hinge as claimed in claim 1, wherein said pivot shaft further comprises a collar connected between said mounting base and said cylindrical shaft body, and an annular groove extending around of the periphery of said cylindrical shaft body and abutted against one side of said collar.

7. The hinge as claimed in claim 1, wherein said mounting portion of each of said knuckle members extends axially from one end of the associate knuckle body, having at least one mounting hole for mounting.
